(19) United States
(12) Patent Application Publication
(10) Pub. No.: US 2007/0039159 A1
(43) Pub. Date: Feb. 22, 2007

(54) Method of forming a cabinet assembly

(76) Inventors: Robert Galbreath, Elkhart, IN (US); Patrick Miller, Goshen, IN (US); Les Gloor, Ligonier, IN (US); Don Scarbeary, Syracuse, IN (US); Steven Hale, Jasper, IN (US); Keith Witte, Jasper, IN (US); Jeff Hagedorn, Ferdinand, IN (US); David MaCkey, Owensboro, KY (US); Wolfgang Veitengruber, Anniston, AL (US); Scott Denuyl, Jasper, IN (US); Greg Krodel, Jasper, IN (US)

Correspondence Address: CALFEE HALTER & GRISWOLD, LLP, 800 SUPERIOR AVENUE, SUITE 1400, CLEVELAND, OH, 44114, US

(21) Appl. No.: 11/506,990

(22) Filed: Aug. 18, 2006

Related U.S. Application Data
(60) Provisional application No. 60/709,175, filed on Aug. 18, 2005.

(51) Int. Cl. B23P 25/00

(52) U.S. Cl. 29/458; 29/462

(57) ABSTRACT

A method of producing a fastener free cabinet assembly. An embodiment of the method includes selecting at least two cross rails and at least two stiles. Each rail has a set of projecting tenons formed at opposite ends of the rail. Each tenon further has a contact surface defined at least in part by a first side surface, an end surface, and a second side surface. Each stile has an edge forming a groove shaped mortise, wherein the mortise forms a contact surface to engage with one of the tenons to define a bond gap. The embodiment also includes applying a predetermined amount of adhesive to each set of tenons, and engaging the at least two cross rails and the at least two stiles to form the cabinet assembly. The predetermined amount of adhesive does not exceed a volume of the bond gap.

### CROSS-REFERENCE TO RELATED APPLICATIONS

This non-provisional application claims the benefit of U.S. Provisional Patent Application No. 60/709,175, entitled “Joinery Process,” filed Aug. 18, 2005, which is hereby incorporated by reference in its entirety.

### FIELD OF THE INVENTION

The present invention relates to a joinery process for assembling parts to a joinery process using adhesive to produce cabinetry assemblies having fastener free joints.

### BACKGROUND OF THE INVENTION

The use of adhesive to assemble product assemblies is well-known. The joinery process used for an exemplary assembly may be defined by several characteristics, including the type of adhesive used, the application technique for the adhesive, the curing environment and conditions, and the properties of the individual assembly parts. As such, certain joinery processes are known in specific art fields, such as for example, processes for the assembly of cabinetry components.

Cabinets are in wide spread use in commercial and residential settings, including kitchens, baths and storage areas. Conventional kitchen and bathroom cabinets, cabinet doors, framing, and trim are assembled by use of tongue-and-groove structure or other indexing methods for attachment geometries. These tongue-and-groove assemblies are generally assembled with white glue (PVAc adhesive) or other wood adhesive, and are typically secured by one or more a mechanical fasteners, e.g., a nail, wire, or staple, to prevent relative part movement during the curing of the adhesive. The fastener acts to secure the parts together in the assembly, such that the parts remain joined during subsequent assembly work. This joinery technique relies upon the one or more metal fasteners to hold the assembled parts together after the parts are unclamped if curing is not sufficiently complete.

Another conventional method of assembly requires a set of external clamps to hold the parts in place, relative to each other, while the adhesive is curing. The clamping time must be of a sufficient length to achieve a bond strength adequate for subsequent handling. The curing time required may be minutes in length, causing this method to be relatively expensive and undesired. Further, many clamps are required for long periods of time. The number and variety of clamps also require considerable assembly line space.

The characteristics of some adhesives used in the art also cause undesired conditions. Some joinery adhesives cure slowly, and only when exposed to ambient conditions, so that no acceleration of cure is possible.

The specific application method of an adhesive is also an important characteristic. Conventional joinery technique uses adhesive dispensers that apply adhesive through a circular orifice, and are metered by pressure, regardless of temperature, viscosity of the adhesive, or the thixotropic condition of the adhesive. Generally, a bead of adhesive is applied to the groove side of the parts to be assembled, and then the parts are roughly assembled, and then clamped. Often, excess adhesive squeezes out of the joinery gaps, and the excess contaminates the visible surfaces, and results in the need for a repair or the marketing of a defective finish on the assembled part.

### SUMMARY OF THE INVENTION

A method of making a fastener free cabinet component is disclosed. An embodiment of the invention includes assembling a plurality of cross rails and a plurality of stiles using a predetermined amount of adhesive. The amount of adhesive does not exceed a bond gap volume between the rails and the stiles. The embodiment offers reduction in material cost, cycle time and production costs over prior art processes.

Further features and advantages of the invention will become apparent from the following detailed description made with reference to the accompanying drawings.

### BRIEF DESCRIPTION OF THE DRAWINGS

FIG. 1 is a front perspective view of a wall cabinet having components constructed in accordance with an embodiment of the present invention;

FIG. 2 is a front view of the wall cabinet of FIG. 1;

FIG. 3 is a top view of the wall cabinet of FIG. 1;

FIG. 4 is a partially exploded view of the wall cabinet of FIG. 1;

FIG. 5 is a front perspective view of a cabinet door constructed in accordance with an embodiment of the present invention;

FIG. 6 is a front view of the cabinet door of FIG. 5;

FIG. 7 is a top view of the wall cabinet of FIG. 5;

FIG. 8 is an exploded view of the wall cabinet of FIG. 5;

FIG. 9 is a front perspective view of a cabinet component, showing an adhesive applied in a pattern to each tenon of a cross rail in accordance with an embodiment of the present invention;

FIG. 10 is a top view of the cross rail of FIG. 9, showing a difference in adhesive amount applied in one side of a tenon as compared to an opposing side of the tenon;

FIG. 11 is a side view of the cross rail of FIG. 9;

FIG. 12 is a front view of the cross rail of FIG. 9;

FIG. 13 is a front view of the cross rail of FIG. 9, showing another adhesive pattern applied to one of the tenons;

FIG. 14 is a front view of a portion of the cross rail of FIG. 9, showing yet another adhesive pattern applied to one of the tenons;

FIG. 15a is a top view of a portion of the cross rail of FIG. 9, shown in relation to a stile after application of adhesive and prior engagement with the stile;

FIG. 15b is a top view of a portion of the cross rail of FIG. 9, showing directional movement of the adhesive during engagement with the stile;

FIG. 16 is a top view of a portion of the cross rail of FIG. 9, showing an exemplary adhesive distribution after engagement with the stile;

FIG. 17 is a front perspective view of an exemplary nozzle apparatus used to dispense adhesive in accordance with an embodiment of the present invention;

FIG. 18 is a cross-sectional view of the nozzle apparatus of FIG. 17;

FIG. 19 is a cross-sectional view of the nozzle apparatus of FIG. 17, shown in relation to a cross rail prior to application an adhesive; and

FIG. 20 is a process flow chart illustrating an embodiment of the present invention.

### DETAILED DESCRIPTION OF THE INVENTION

This Detailed Description of the Invention merely describes embodiments of the invention and is not intended to limit the scope of the invention in any way. Indeed, the invention as described is broader than and unlimited by the discussed embodiments, and the terms used have their full ordinary meaning.

The present invention overcomes many deficiencies of the prior art. The present invention includes a process for manufacturer of a cabinet assembly. The assembly includes fastener free joints. The process features several advantages over the prior art, including reduced cycle time, reduced cure time, reduced number of external clamps, and reduced material cost without decreasing bond strength.

This invention is a joinery process in which an adhesive is metered, dispensed, and distributed, and the elements to be joined are clamped and the adhesive is dried or cured. The process achieves a low cost, high green strength, fast cure or dry, and high final-strength, with distribution and bond limited to the joint, rather than outside of the joint. The joinery may be mobile, within a moving clamp, for processing and can include the step of accelerating the cure of the adhesive. The joinery can be assembled without mechanical fasteners such as nails, screws or staples, because the high-strength and fast cure allows for fastener-free assembly. The joinery may include the application of a water mist to increase curing speed of certain adhesives.

For exemplary purposes only, the invention will be discussed in relation to a mortise and tenon joint design. It should be apparent to others with ordinary skill in the art that the invention could be practiced with other joint designs, such as for example, French dovetail, miter, and various wedge shaped designs. Furthermore, joint designs of various tolerances can be used in the practice of the present invention. This joint assembly is also applicable for regular mortise and tenon construction, miter construction, e.g. 45 degrees, or any intermediate angle joint or lap construction.

A preferred embodiment of the present invention includes the application of adhesive to the ends of the tenons, as opposed to the application of adhesive to the mortise of door and frame joints. In other words, the application of the adhesive is made to the tongue of the tongue-and-groove assembly, otherwise known as the tenon in a mortise-and-tenon joint. Various adhesives, bead application techniques, and application patterns may be used in the practice of this invention.

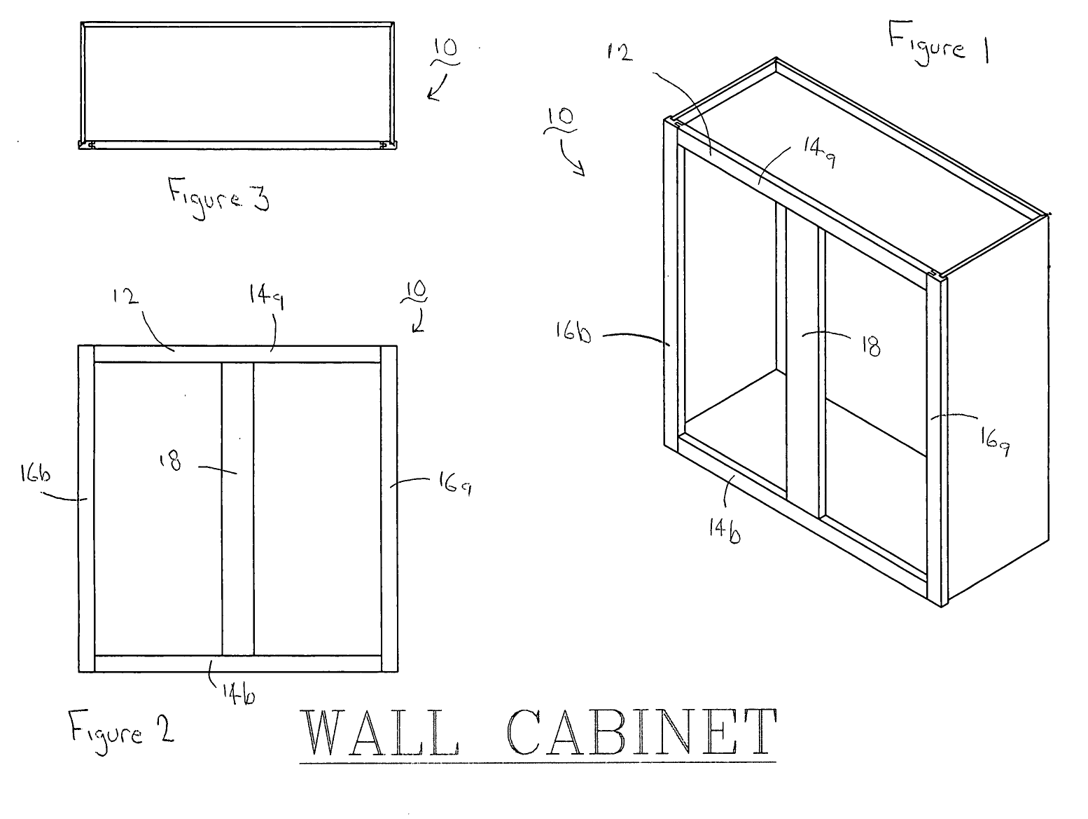

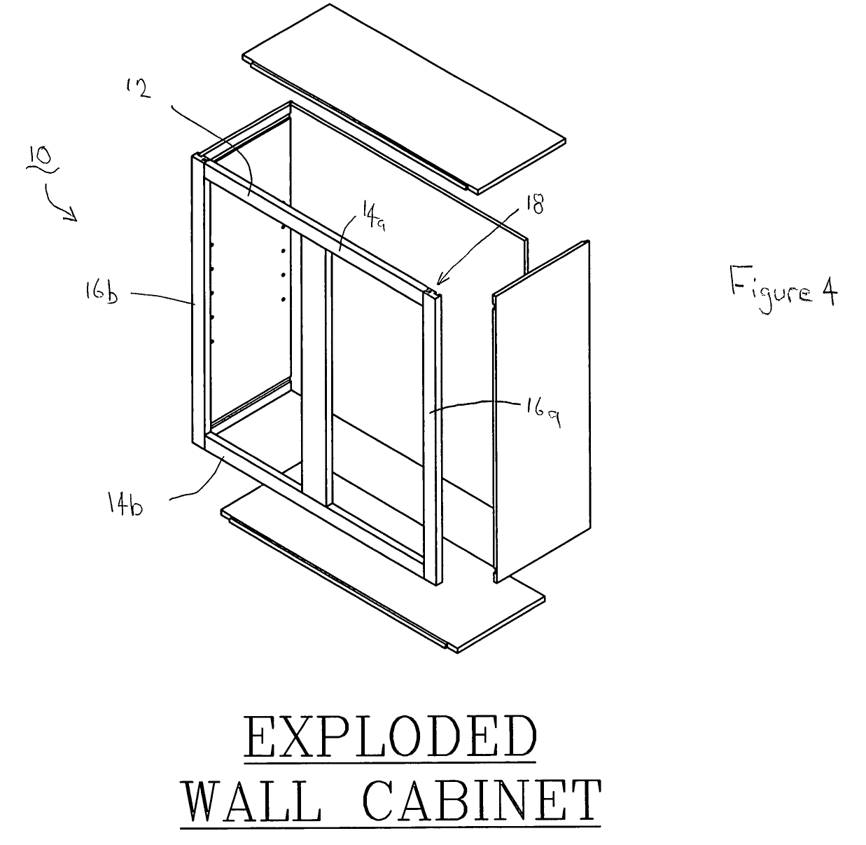

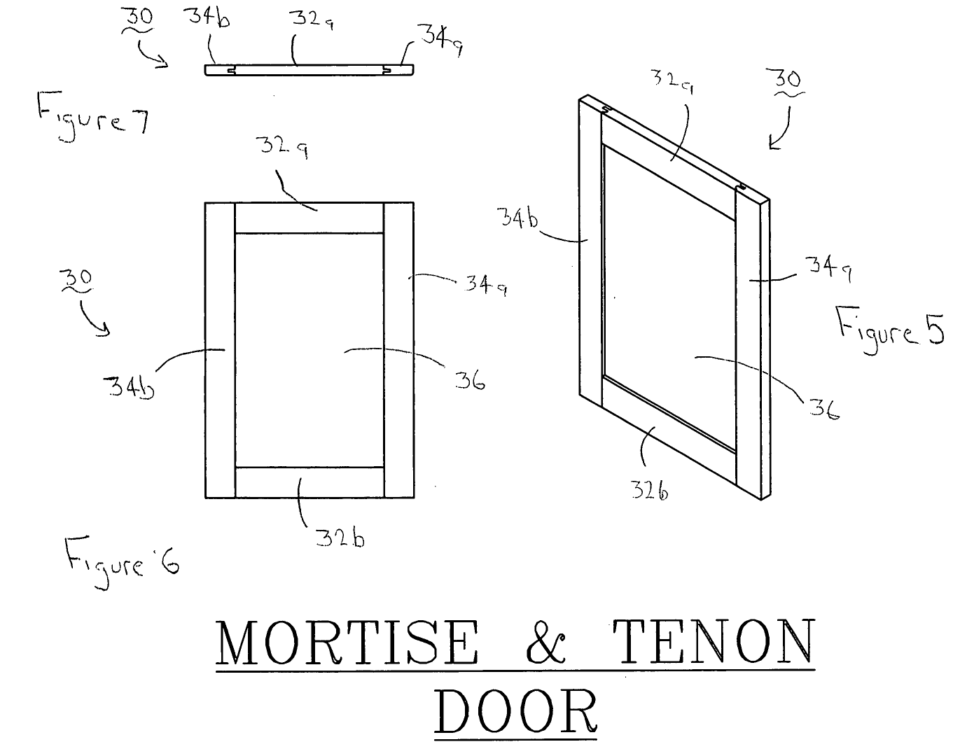

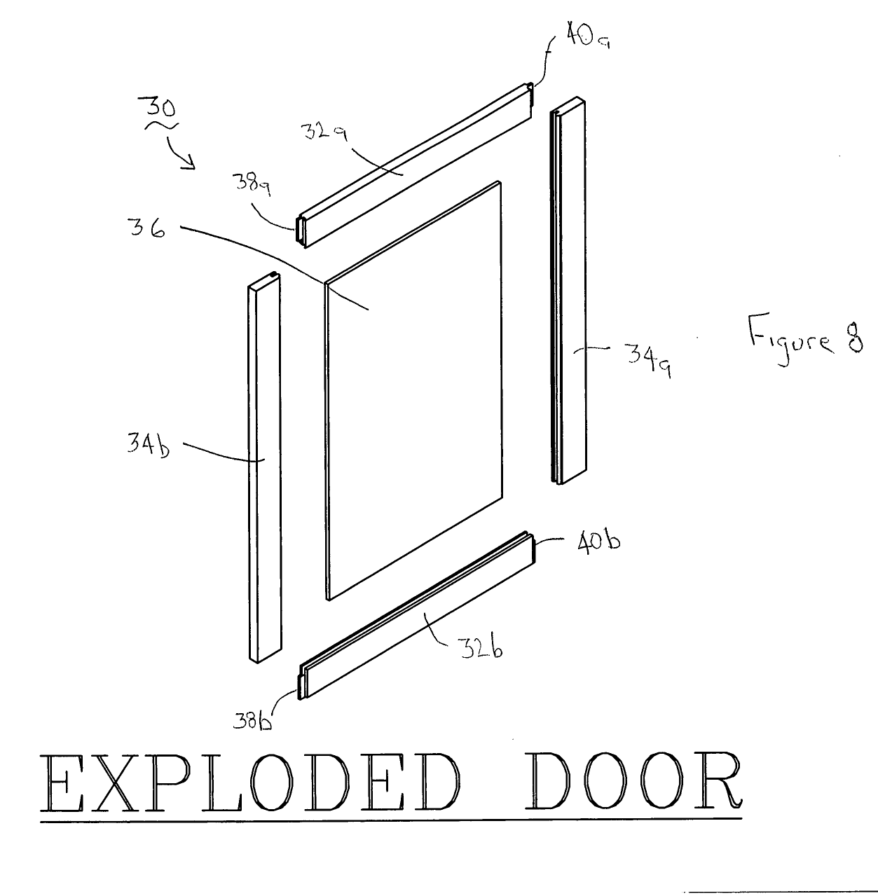

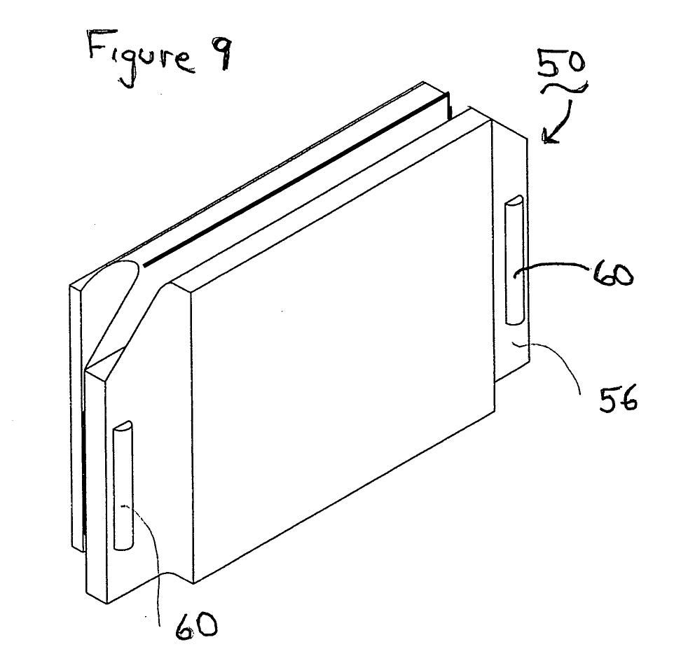

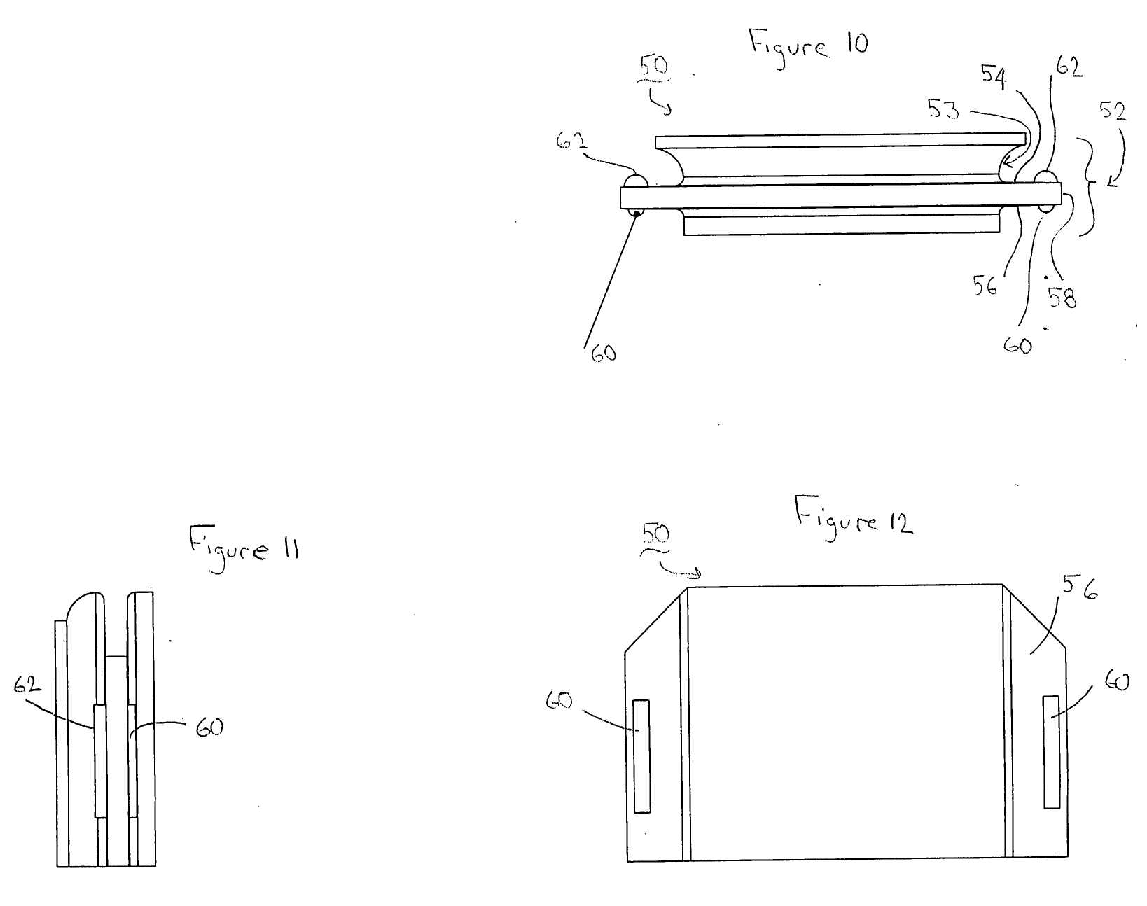

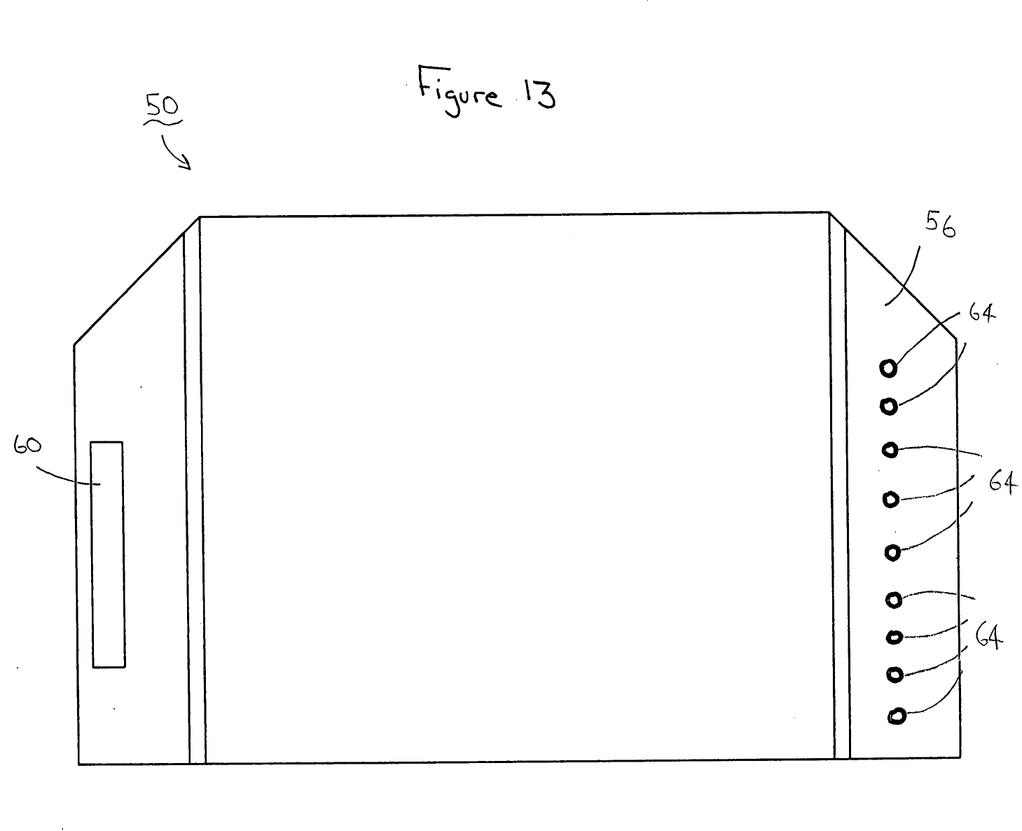

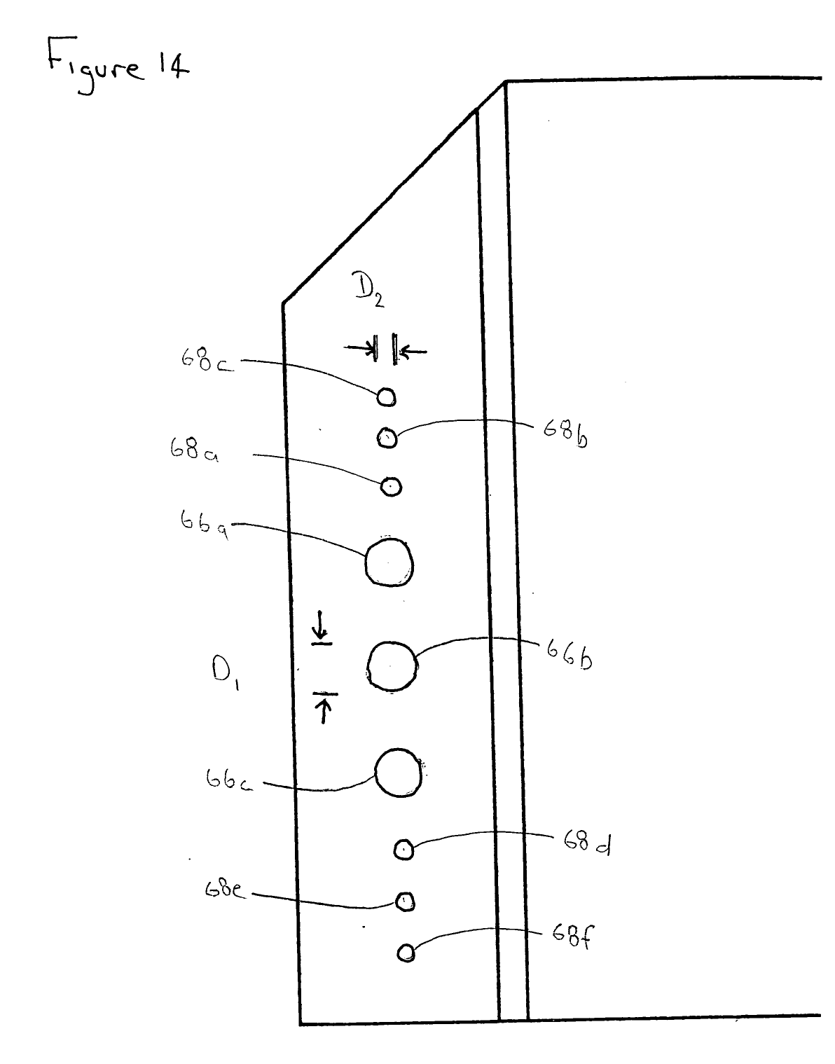

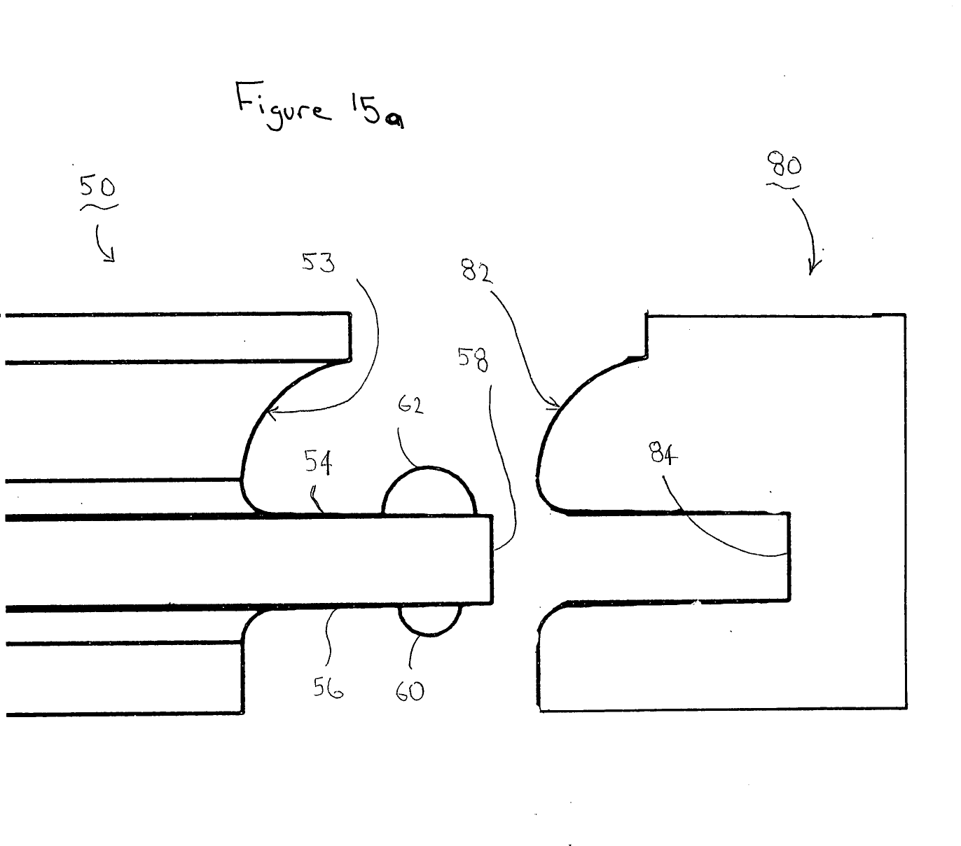

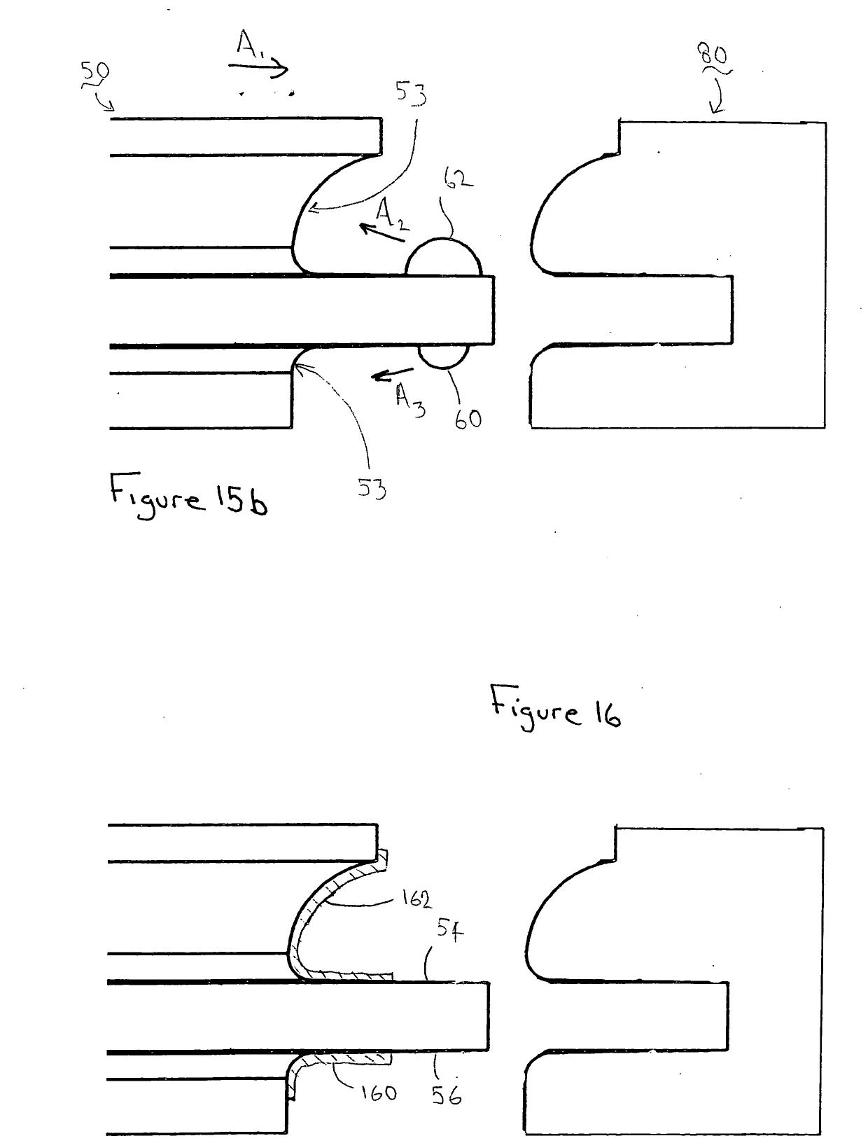

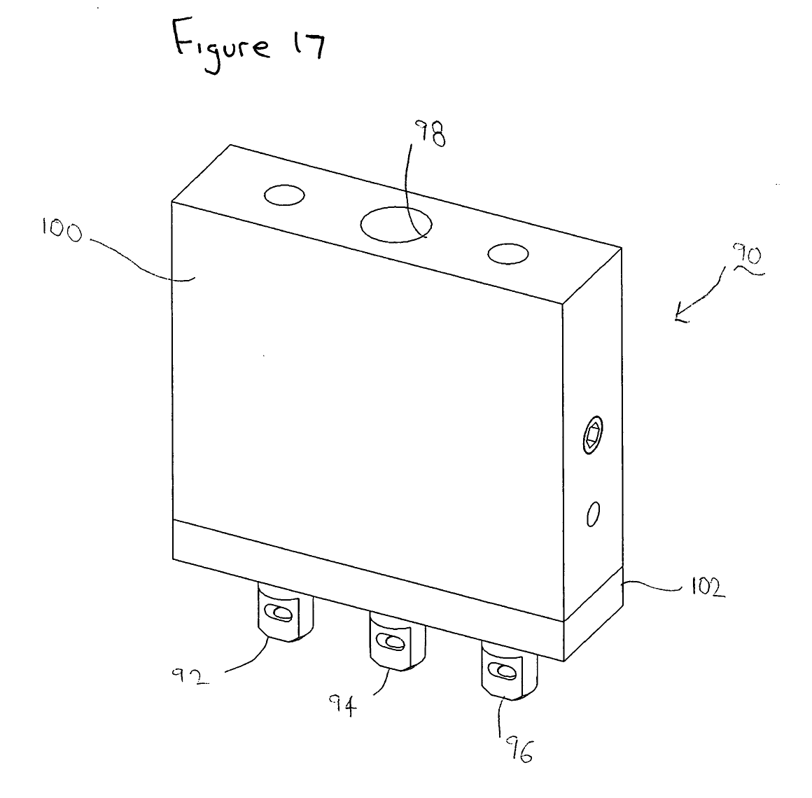

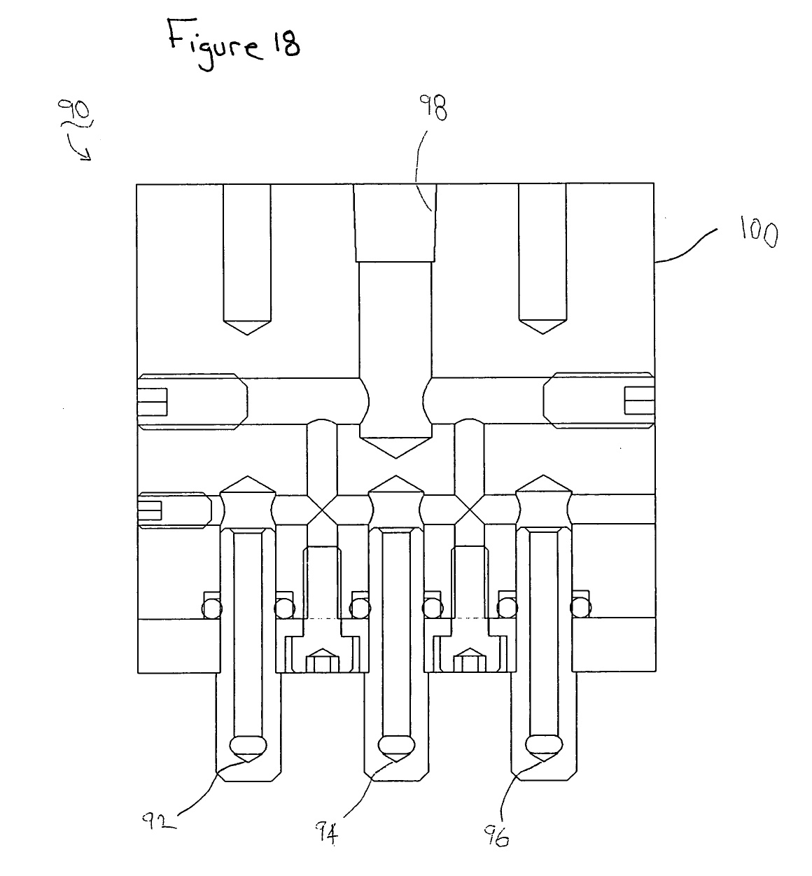

Referring now to the drawings, FIG. 1 is a front perspective view of a wall cabinet 10 having components constructed in accordance with an embodiment of the present invention. The cabinet 10 includes a rectangle-shaped frame 12 formed by ajoinery process. An upper horizontal rail 14a and a lower horizontal rail 14b connect two vertical stiles 16a, 16b. A center vertical divider 18 is dispose equidistant between the stiles 16a, 16b . FIG. 2 is a front view of the wall cabinet 10. A top view of the wall cabinet is shown in FIG. 3.

It should be understood that the invention can be practiced to produce a wooden cabinet frame, a wooden cabinet door, or any other assembly having joints bound by an adhesive. It should also be understood that wood rails and wood panels are discussed for exemplary purposes only and the invention can be applied to a wide variety of structures, designs, and component materials, such as for example, plastic, corrugate, or metal. Further, the assembly produced can have any number of rails, dividers or styles and be shaped to include right angles, obtuse angles, acute angles, or any combination thereof.

The frame 12 of the wall cabinet 10 is formed by four mortise and tenon joints bonded only by an adhesive. No fasteners of any type are required to complete the bonds. The stiles are machined to form a mortise, or a groove, and the rails are machined to form a tenon, or a projecting tongue. Specifically, a tenon is formed on either end of the rails 14a, 14band a mortise is formed on one edge of the stiles 16a, 16b. In FIGS. 1-4, the inward edges of the stiles 16a, 16b contain the mortise. A top perspective view of a mortise and tenon joint 18 is illustrated in a partially exploded view of the wall cabinet shown in FIG. 4.

Another example of a cabinet assembly having mortise and tenon joints is a cabinet door. A front perspective view of a cabinet door 30 constructed in accordance with an embodiment of the present invention is shown in FIG. 5. This exemplary cabinet door 30 is shown in a front view in FIG. 6 and a top view in FIG. 7. The door 30 includes two cross rails 32a, 32b, two stiles 34a, 34b and a panel 36. The rails 32a, 32b are bound together to the stiles by a bonding process, effectively nesting the panel 36 within the external frame created by the process.

Referring now to FIG. 8, an exploded view of the wall cabinet 30 is shown. The tenons 38a, 38b of the cross rails 32a, 32b, respectively, are shown at one end of the rails. Tenons 40a, 40b are formed at the opposing ends of each cross rail 32a, 32b, respectively. During the joinery process, the rails slide into the stiles. In this engagement, the tenon and mortise act as a tab and a slot, or a tongue and groove, to make a joint. The surface area of contact in a door tenon and mortise joint will vary by size and design of the door. An exemplary surface area is about 3 square inches, although the practice of this invention is not limited to any particular surface area.

The profiles of an individual mortise and tenon need to be machined to a profile tolerance so that when the parts are mated, the gap between the parts is near to uniform. Consequently, the bond gap space will be uniform for adhesive consistency and strength optimization. For purposes of example only, a typical tolerance for a profile of a mortise or a tenon is in the range of +/−0.006″ across the entire width of the mortise and is +/−0.006″ across the entire width of the tenon. Consequently, the stack, i.e., the bond gap size or width, tolerance is +/−0.012″. The significance of a bond gap tolerance will be discussed later in further detail.

A perspective view of a cross rail 50 comparable to the cross rail 32bof FIGS. 5-8 is shown in FIG. 9. The length of the cross rail 50 is illustrated in a truncated length for convenience only. Any length cross rail may be used in the practice of the present invention. FIG. 9 also shows an adhesive applied in a pattern to each tenon of the cross rail 50. A top view, side view, and front view of the cross rail 50 are shown in FIGS. 10-12, respectively.

As best shown in FIG. 10, the cross rail 50 is formed to include two projecting tenons at opposing ends of the rail. For purposes of example, the structure of one tenon will now be discussed. The tenon 52 has a contact surface 53 that is shaped to cooperatively engage with a contact surface of a mortise. As discussed, the relatively small space between these contact surfaces when the mortise and tenon joint is assembled defines a bond gap. The tenon contact surface 53 is defined at least in part by a first side surface 54, a second side surface 56, and an end surface 58. Exemplary side surfaces are between 1″,and 3″ depending on door size and design. The end surface 58 is disposed between the first side surface 54 and the second side surface 56.

A preferred embodiment of the present invention includes the application of the adhesive to the cross rails 32a, 32brather than to the stiles 34a, 34b. Wood has a tendency to twist and bow after being cut into elongated pieces, such as cabinet door stiles. The application of adhesive to a door stile requires relatively high precision and control. By design, a cross rail of a cabinet door is typically shorter in length than a stile. As a result, applying adhesive to the shorter cross rail, rather than the longer stile, allows tighter control of the adhesive application because the effects of twisting and bowing are reduced.

Referring again to FIG. 9, an adhesive application pattern is shown. The side surfaces 54, 56 are application points for applying an adhesive. A single elongated bead 60 is shown applied to the second side surface 56. An exemplary width of the bead 60 is 3/16″ on a 1″ wide surface. As shown in FIGS. 10-11, a single elongated bead 62 is shown applied to the first side surface 54. An exemplary width of the bead 60 is ⅜″ on a 1 ″ wide surface. As such, the beads 60, 62 shown are less than half the width of the side surfaces 56, 54, but it should be understood that the width, depth and shape of the applied adhesive bead may vary in the practice of this invention. Further, the location of the bead may vary from the outside edge to the inside edge of the side surface 54, 56, with respect to the end surface 58.

In an embodiment of the invention, the amount of application in one area of the cross rail 50 may differ than in another area. Referring again to FIG. 10, a difference in adhesive amount applied in opposing sides 54, 56 of the tenon 52 is apparent. The continuous bead 62 applied to the first side surface 54 is larger in width and height than the bead 60 applied to the second side surface 56. Selection of this and other adhesive patterns in the practice of this invention are designed to control adhesive bond characteristics, i.e., adhesive volume, adhesive travel and location during joinery, and bond strength.

The pattern of adhesive application can vary by other characteristics. The illustrated beads 60, 62 are a single continuous bead, although the adhesive can be applied in various patterns, such as for example, continuous bead, intermittent bead, flat extrusion, stitching or spotting. An example of an intermittent bead pattern in shown in FIG. 13. A series of equidistantly spaced and equal volume beads 64 are shown applied to the second side surface 56. A continuous bead 60 is shown on the opposing tenon first side surface for comparison purposes. Yet another adhesive pattern is shown in FIG. 14. The pattern includes three equidistantly spaced beads 66a, 66b, 66c of a common diameter D₁. Also on the tenon surface and placed relative to the top side of the beads 66a, 66b, 66c, three equidistantly spaced beads 68a, 68b, 68c of a common diameter D₂ are disposed. On the opposing side of the center beads 66a, 66b, 66c, three similarly spaced beads 68d, 68e, 68f of a common diameter D₂ are disposed. The diameter D₁ is illustrated larger than the diameter D₂. As such, the adhesive pattern shown is created by applying a predetermined amount of an adhesive to the center of the tenon in beads of larger diameter than the beads applied near the opposing longitudinal ends of the tenon. These and other embodiments of the present invention illustrated in FIGS. 10-14, with regard to adhesive pattern selection, advantageously limit adhesive amounts and restrict adhesive to within the bond gap after tenon and mortise engagement.

The engagement of the stile and cross rail occurs after application of the adhesive in a predetermined amount and pattern. FIG. 15a is a top view of a portion of the cross rail 50, shown in relation to a stile 80, after application of adhesive to the cross rail and prior engagement with the stile. For reference, this joint is in similar relation to the joint at the bottom right corner of FIG. 8. In this position, adhesive has been applied to each tenon disposed at the opposing ends of the cross rail 50, and to the first side surface 54 and second side surface 56 of each tenon. As discussed, the stile 80 forms a mortise on one edge that includes a groove 84. The mortise defines a contact surface 82, which with the tenon contact surface 53, defines a joinery bond gap between the parts 50, 80.

FIG. 15b is a top view of a portion of the cross rail 50 and the stile 80. During engagement, the cross rail 50 is slide into the stile 80 in the direction A₁. In an embodiment of the invention, the beads 62, 60 are forced in the general directions A₂, A₃ toward the tenon contact surface 53. An exemplary adhesive distribution after engagement with the stile 80 is shown in FIG. 16. The bead 60 on the second side surface 56 has been dispersed to form a film 160 as shown. Likewise, the bead 62 on the first side surface 54 has been dispersed to form a film 162 as shown. As such, the predetermined amount of applied adhesive, i.e., the combined beads 60, 62, do not exceed a volume of the bond gap. In other words, the adhesive remains within the mortise and tenon, so no adhesive squeezes out and is visible on the outside of the stile edge or cross rail edge.

In an embodiment of the present invention, adhesive bond location is also controlled at least in part by a ratio between the bond gap volume (in³) to the tenon contact surface (in²). In a preferred embodiment, the ratio is between 0.0 and 0.012 inches. This ratio was determined and confirmed by use of a testing procedure where joints were tested in shear, a few seconds after assembly, to determine the appropriate green strengths of the joinery. In the case of the PVAc, and PUR adhesives, the strengths dropped significantly where the ratio was increased beyond 0.012 inches.

As discussed, a process step in this invention is the delivery of adhesive to desired locations on wooden cabinet components. In an embodiment of the invention, the adhesive is delivered via a balanced manifold to a plurality of dispensing nozzles. The manifold may be symmetrical, i.e., the channels that lead to the nozzles of similar diameter and length, so that all of the nozzles receive the same back-pressure and all of the nozzles receive equal flow of adhesive. Each nozzle may be circular, square or another shape, and include a pulsating head and an air knife to terminate residual flow after dispensing ends. The manifold and nozzle assembly is designed for delivery of adhesive to the tenon portion of the joint, but can be used for adhesive delivery to other locations.

A front perspective view of an exemplary nozzle apparatus used to dispense adhesive in accordance with an embodiment of the present invention is shown in FIG. 17. The nozzle assembly 90 includes three equidistantly spaced nozzles 92, 94, 96. Adhesive first enters the assembly 90 through an inlet port 98. A manifold housing 100 and nozzle plate 102 are included. Either within the manifold housing 100, or upstream in the adhesive supply line, an adhesive reservoir is included which maintains a constant volume. As such, the distribution of adhesive through each nozzle 92, 94, 96 is metered by volume and not pressure or time.

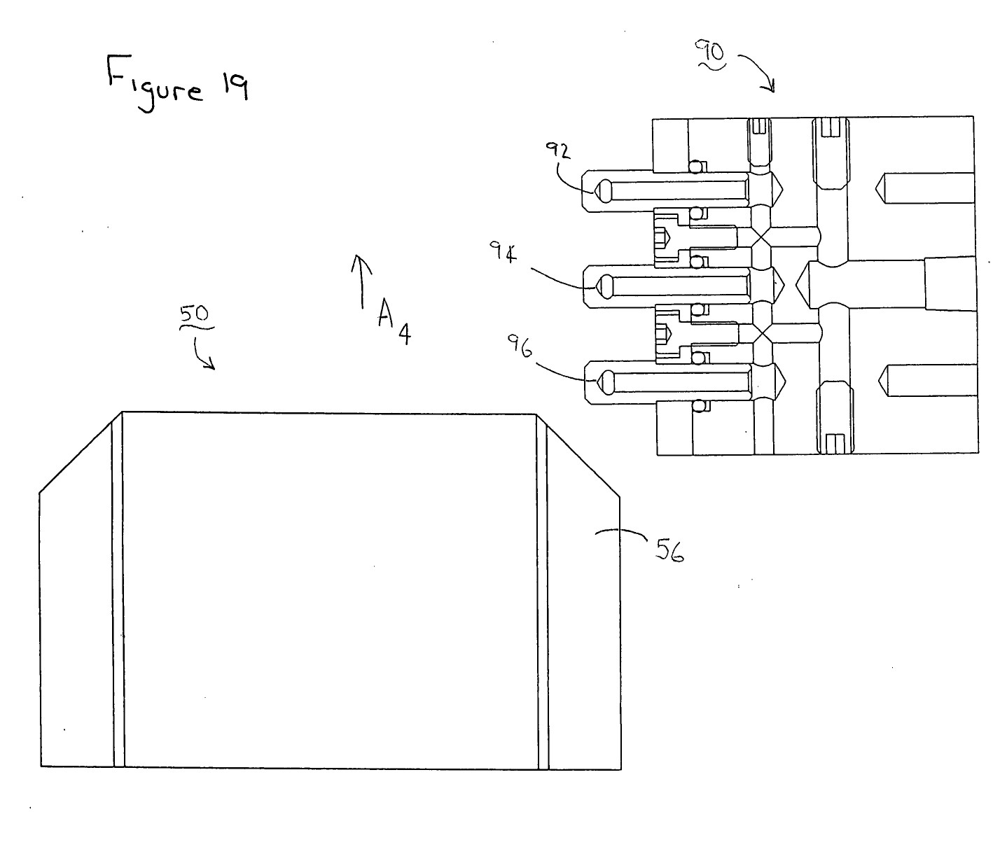

A cross-sectional view of the nozzle apparatus 90 is shown in FIG. 18. The illustrated structure is for exemplary purposes only and other nozzle designs can be utilized in the practice of this invention. Further, the invention can be practiced by modification of this structure by a person with ordinary skill in the art for delivery of adhesive to the tenon portion of the joint.

Another preferred embodiment of the present invention includes the step of applying adhesive to the tenons as the tenons move transverse to the nozzle. This technique positions the nozzles in a horizontal position, rather than vertical, and prevents the nozzle from dripping on stationary or moving cabinet parts. An example of such a technique is illustrated in FIG. 19, which shows a cross-sectional view of the nozzle apparatus 90 in relation to a cross rail 50 prior to application an adhesive. The relation in size between the nozzle apparatus 90 and the cross rail is exemplary and for convenience only. In the example shown, the cross rail 50 moves in a direction A4 as the tenon dispenses adhesive in a desired pattern. As such, adhesive is applied in a direction toward the end surface 58, best shown in FIG. 10, of each set of tenons, resulting in adhesive nozzle flow essentially parallel to the side surfaces 54, 56 and perpendicular to the end surface 58. Other transverse orientations of the nozzles 92, 94, 96 and the cross rail 50 are possible in the practice of this invention. Further, adhesive may be dispensed from any combination of nozzles depending on the length of the tenon side surface. As discussed, the pattern formed may vary in bead size, shape and location.

Various adhesives can be used in the practice of this invention. An embodiment of the present invention uses polyurethane reactive (PUR) adhesive. This adhesive is typically applied from a heated cartridge or roller coater. It is applied hot (about 250° F is typical), spread to a thin film, and sets quickly as it cools. In this respect, it is like a conventional hot melt adhesive. It achieves its ultimate strength several days after application by reacting with moisture in the surrounding air and/or in the substrates to form a significantly stronger bond than a conventional hot melt. Certain technologies cannot be used to accelerate the curing process. In cabinet processing, it is applied by various techniques and binds as a thin-film between two substrates.

Another embodiment of the present invention includes a process of applying an emulsion glue, such as for example, a conventional white wood glue. Polyvinyl acetates (PVAc's) are well-known adhesives that are used in a variety of formulas for many different applications. PVAc's are designed to work on porous materials only and are water based, so they clean up with warm soapy water. A PVAc adhesive needs pressure to adhere and must completely dry out to bind. In the wood processing industry, clamps are used to force the water out of the joining area.

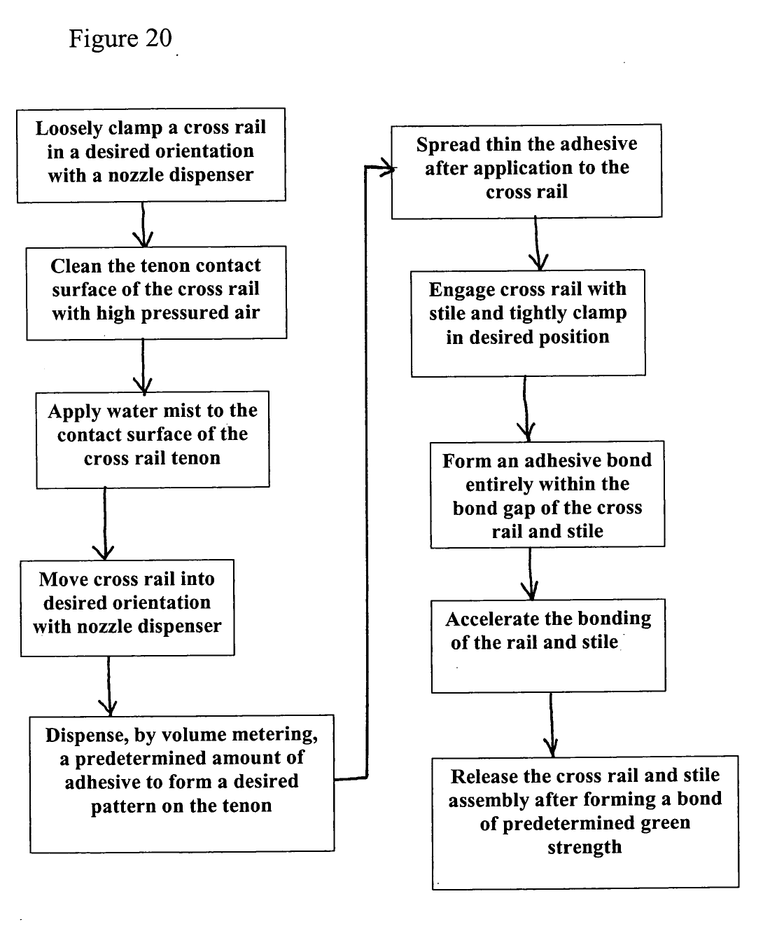

The process steps of an embodiment of the present invention will now be discussed. FIG. 20 is a process flow chart illustrating an embodiment of the present invention. The process begins with selecting a desired combination of cross rails and stiles to form a cabinet component, such as for example, a cabinet door. At an assembly station, the wooden elements are loosely assembled in the clamp. The tenon joint can have adhesive applied to it before the positioning of elements in the clamp, or the adhesive can be applied after the elements are loosely assembled in a clamp. The components are held in the loose clamping device in the desired orientation. Prior to application of any adhesive, the tenon side surfaces can be cleaned with high pressured air to remove sawdust, dirt, or other contaminants.

The process chart illustrated in FIG. 20 includes several steps included in an embodiment using PUR adhesive. The embodiment includes the application of water to increase the moisture content of one or more of the joining surfaces. In general, moisture in the surrounding air serves to crosslink and cure the PUR adhesive after a retaining clamp is closed. In this embodiment, additional water is used to accelerate the curing process as a supplement to the natural water content that exists within the wooden parts. A mist of steam is applied to the joint surface area that is opposite to the surface area upon which the adhesive is applied. Alternatively, the adhesive may be applied first. The misted surface mates with the opposing surface, which is covered with a thin film of adhesive. The mist raises the speed of cross linking of the isocyanate in the urethane adhesive to shorten the cure time while still producing a bonding of sufficient strength.

Alternatively, the mist of steam may be applied to the same surface upon which the adhesive is applied. In this technique, beads of adhesive are applied in a defined pattern. Subsequently or at the same time, mist is applied upon surface areas between the beads. When the glue beads are spread into a thin film substantially covering the surface, a thin film is formed over a surface of increased moisture content as compared to the substrate prior to the mist application.

These and other techniques within the scope of the invention use water to raise the moisture content of the substrate. Almost immediately after application, the substrates are pressed together so little moisture content is evaporated. After a short period in which the parts are being held by a mechanical clamp, the parts are unclamped and the assembly is transported for subsequent processing.

Returning to the flow chart, the PUR adhesive is applied by a nozzle system to the tenons as previously discussed, although any suitable nozzle system may be used. Because, the adhesive is applied to the tenons of the cross rails, the footprint of the machine assembly required to dispense the adhesive can be relatively small. For example, a machine of no more than 5 feet in length can be used for cross rails 36″ long. The adhesive is pumped into a known volume of space in a fluid cylinder, and then that exact amount of adhesive volume is transferred to the element to be bonded within the joinery. The adhesive is transported from the known volume cylinder to a manifold before the nozzles. The nozzles apply the adhesive in a predetermined amount and pattern, and then swipe the bead pattern to increase the wetting of the adhesive on the element, i.e., distribute the adhesive bead or beads into a thin film. The nozzles are positioned so that if unwanted dripping occurs after the swiping action, the dripping occurs within the machinery, and not on any of the elements of the joinery. There is a dwell time, such as for example, 20 to 40 seconds, after swiping where the assembly components can be orientated as desired.

Next, the clamping device is activated and the elements of the joints are brought closer until adhesive is squeezed into the bond gap between the elements. The clamp then moves to the next operational position where acceleration of cure time occurs. For example, in the case of PVAc adhesives, electromagnetic energy, such as for example, radio frequency (RF) energy, can now be applied to the joint to heat the PVAc adhesive to accelerate the cure. The adhesive is cured within the joinery, all within the movable clamp. RF energy is applied to PVAc adhesive because of its effects upon water within the adhesive. Water is a polar molecule, rather than a symmetric molecule. Water absorbs RF energy and converts it to heat. Consequently, the increase in temperature accelerates the drying of the PVAc adhesive.

Other forms of energy may be used to cure the adhesive, such as for example, microwave, ultrasonic, humidity, heat or sonic energy.

After a dwell time in which the bond has reached a desired green strength to allow for additional handling and assembly, the joinery moves to the next assembly position and generally is separated from the clamp, so that the clamp can cycle back to join another group of elements in the joinery process. Green strength is the adhesive joint strength immediately after the clamp is opened. Exemplary PUR adhesives may reach a strength of 60 psi in one minute and 200 psi in three minutes. After the clamping has been removed, the PUR adhesive continues to crosslink, resulting a joint strength of at least 475 psi for a bond gap of 0.012 inches.

While several embodiments of the invention have been illustrated and described in considerable detail, the present invention is not to be considered limited to the precise constructions disclosed. Various adaptations, modifications and uses of the invention may occur to those skilled in the arts to which the invention relates. It is the intention to cover all such adaptations, modifications and uses falling within the scope or spirit of the claims filed herewith.

what is claimed is:

1. A method of producing a fastener free cabinet assembly comprising:
a) selecting at least two cross rails, each rail having a set of projecting tenons formed at opposite ends of said rail, each tenon having a contact surface defined at least in part by a first side surface, a second side surface, and an end surface disposed between said first side surface and said second side surface;
b) selecting at least two stiles, each stile having an edge forming a groove shaped mortise, wherein said mortise forms a contact surface to engage with one of said tenons to define a bond gap;
c) applying a predetermined amount of adhesive to each set of tenons; and
d) engaging said at least two cross rails and said at least two stiles to form said cabinet assembly;
e) wherein said predetermined amount of adhesive does not exceed a volume of said bond gap.

2. The method of claim 1 comprising applying adhesive to each set of tenons at a plurality of locations on each of said sets.

3. The method of claim 1 comprising applying adhesive to each front side surface and each second side surface of said each set of tenons.

4. The method of claim 1 comprising applying adhesive to each first side surface and each second side surface of each set of tenons, wherein a volume of adhesive applied to said first side surface is more than the adhesive applied to said second side surface.

5. The method of claim 1 comprising inserting one of said at least two rails into said one of said at least two stiles, wherein adhesive applied to said tenon is forced in the direction of said tenon contact surface.

6. The method of claim 1 comprising applying adhesive in a direction toward said end surface of each set of tenons, wherein adhesive flow is essentially parallel to said first side surface.

7. The method of claim 1 comprising stopping any adhesive residual flow after applying said predetermined amount by application of an air knife.

8. The method of claim I comprising clamping said at least two cross rails in a desired position relative to said at least two stiles prior to applying adhesive.

9. The method of claim 1 comprising clamping said at least two cross rails in a desired position relative to said at least two stiles after engagement to form said cabinet assembly.

10. The method of claim 1 comprising wiping said adhesive applied to at least one of said each set of tenons, wherein said adhesive is thinner in dimension than as applied.

11. The method of claim 1 comprising applying a predetermined amount of adhesive to each set of tenons, wherein a ratio of said bond gap volume (in³) to said tenon contact surface (in²) is between 0.0 and 0.012 inches.

12. The method of claim 1 wherein said applying a predetermined amount of an adhesive is metered by volume and not pressure or time.

13. The method of claim 1 wherein said applying a predetermined amount of an adhesive creates a pattern of beads, wherein said beads applied near the center of said tenon are larger in diameter relative to said beads applied near the opposing longitudinal ends of the tenon.

14. A method of producing a fastener free cabinet assembly comprising:
a) selecting at least two cross rails, each rail having a set of projecting tenons formed at opposite ends of said rail, each tenon having a contact surface;
b) selecting at least two stiles, each stile having an edge forming a groove shaped mortise, wherein said mortise is sized to engage with one of said tenons to define a bond gap;
c) applying a predetermined amount of an adhesive to each set of tenons with a nozzle;
d) spreading said predetermined amount of an adhesive across said tenon by a movement of said nozzle;
e) clamping said at least two cross rails and said at least two stiles to form said cabinet assembly; and
f) accelerating a bonding rate of said adhesive.

15. The method of claim 14 wherein said adhesive is a polyurethane reactive adhesive.

16. The method of claim 14 wherein a radio frequency (RF) energy source is used to accelerated said bonding rate of said adhesive.

17. The method of claim 15 comprising increasing the water content of said tenon by applying a water mist to said tenon contact surface.

18. The method of claim 15 comprising cleaning said tenon contact surface by high pressured air.

19. The method of claim 14 comprising applying a predetermined amount of adhesive to each set of tenons, wherein a ratio of a bond gap volume (in³) between said tenon and said mortises to said tenon contact surface (in²) is between 0.0 and 0.012 inches.

20. The method of claim 14 wherein said applying a predetermined amount of an adhesive is metered by volume and not pressure or time.

21. The method of claim 14 wherein said adhesive is a polyvinyl acetate glue.

22. A method of producing a fastener free cabinet assembly comprising:
a) selecting at least two cross rails, each rail having a set of projecting tenons formed at opposite ends of said rail, each tenon having a contact surface;
b) selecting at least two stiles, each stile having an edge forming a groove shaped mortise, wherein said mortise is sized to engage with one of said tenons to define a bond gap;
c) selecting an adhesive dispenser having a plurality of dispensing nozzles;
d) transversing one of said at least two cross rails across said plurality of dispensing nozzles;
e) applying a predetermined amount of an adhesive with at least one of said plurality of nozzles in a predetermined pattern to said contact surface of each set of tenons;
f) clamping said at least two cross rails and said at least two stiles to form said cabinet assembly;
g) holding said cabinet assembly during a predetermined cure dwell time; and
h) releasing said cabinet assembly after forming a bond of predetermined green strength between said at least two cross rails and said at least two stiles.

23. The method of claim 22 comprising applying a predetermined amount of adhesive to each set of tenons, wherein a ratio of a bond gap volume (in³) between said tenon and said mortises to said tenon contact surface (in²) is between 0.0 and 0.012 inches.

24. The method of claim 22 wherein said adhesive is a polyurethane reactive adhesive and a RF source is used to accelerate a curing rate of said adhesive.

25. The method of claim 22 comprising increasing the water content of said tenon by applying a water mist to said tenon contact surface.

26. The method of claim 22 comprising cleaning the tenon contact surface by high pressured air.

27. The method of claim 22 wherein said predetermined pattern of an adhesive is a series of beads.

28. The method of claim 22 wherein said predetermined pattern of an adhesive is a set of beads, wherein said beads applied near the center of the tenon are larger in diameter relative to said beads applied near the opposing longitudinal ends of the tenon.

29. The method of claim 22 comprising inserting one of said at least two rails into said one of said at least two stiles, wherein adhesive applied to said tenon is forced in the direction of said tenon contact surface.

30. The method of claim 22 wherein an energy source is used to accelerated a bonding rate of said adhesive.
